(19) United States
(12) Patent Application Publication
(10) Pub. No.: US 2014/0039893 A1
(43) Pub. Date: Feb. 6, 2014

(54) Personalized Voice-Driven User Interfaces for Remote Multi-User Services

(71) Applicant: Steven Weiner, Merion Station, PA (US)

(72) Inventor: Steven Weiner, Merion Station, PA (US)

(73) Assignee: SRI INTERNATIONAL, Menlo Park, CA (US)

(21) Appl. No.: 13/562,733

(22) Filed: Jul. 31, 2012

(51) Int. Cl. G10L 17/00

(52) U.S. Cl. 704/249; 704/246; 704/E17.001

(57) ABSTRACT

Disclosed embodiments provide for personalizing a voice user interface of a remote multi-user service. A voice user interface for the remote multi-user service can be provided and voice information from an identified user can be received at the multi-user service through the voice user interface. A language model specific to the identified user can be retrieved that models one or more language elements. The retrieved language model can be applied to interpret the received voice information and a response can be generated by the multi-user service in response the interpreted voice information.

### FIELD OF THE INVENTION

At least one embodiment of the present invention relates to providing a user personalized voice driven interface for a remote multi-user service.

### BACKGROUND INFORMATION

Enabling users to access computer systems and information through spoken requests and queries is an important goal and trend in the computer industry. Much work in the field of speech recognition has been done, but still further improvement of quality and performance remains important.

One promising and sometimes helpful technique is to personalize or adapt the language model used by a speech recognition engine to reflect the individual characteristics of an individual user's speech patterns. For example, the user's accent and pronunciation preferences may be taken into account by a personalized language model used by recognition engine in determining the contents of that user's utterances. Constructing a personalized model of that nature typically entails having the user interactively “train” the engine to recognize that user's individual characteristics by providing samples of the user's speech. Many service providers that provide interactive electronic services to a broad range of users have not yet speech-enabled their services, while the minority who have done so (e.g., interactive voice response systems for airline ticket purchase and the like) typically do not utilize user-specific personalized language models—presumably, at least in part, because such systems are intended to serve very large numbers of different users in a large number of relatively brief sessions. Training and maintaining personalized acoustic models for each individual user/subscriber appears unattractive.

Increasingly, important digital collections of our personal information and content reside “in the cloud” in personal accounts with various remote service providers. For example, many individuals have cloud-based accounts for digital music libraries and playlists (Apple iCloud), and/or custom music “stations” (Pandora); digital photos/videos; contacts and biographical information (LinkedIn); favorite restaurants (OpenTable); online access to financial/bank accounts; email, calendar, online groups, etc. Enabling voice-based access to such information services and repositories offers great value, particularly for the large and still-growing group of mobile-device users.

### SUMMARY OF THE INVENTION

The inventor recognized a need for a technology through which highly effective, user-personalized speech recognition can be leveraged by a voice-enabled, cloud-based service supporting a large number of users/subscribers. Many remote multi-user services may be hesitant or limited in their adoption and deployment of a speech recognition capability at least partly because of a perceived lack of sufficient recognition accuracy, while those existing speech-enabled remote multi-user services typically deploy solutions without adequate user-personalization, which can lead to frustrating speech recognition errors. The inventor recognized that personalization of speech recognition to a specific user in multi-user services could improve the user's experience with the multi-user services.

In particular, the inventor recognized that providing a personalized language model on a user-by-user basis can allow a multi-user service to improve a speech recognition interface with such services. The inventors also recognized that benefits and advantages can be achieved by generating personalized language models for each of the users of remote multi-user services that take into account user information specific and/or unique to each of the users.

In one aspect, a computer-implemented method for personalizing a voice user interface of a remote multi-user service is disclosed. The method includes providing a voice user interface for the remote multi-user service and receiving voice information from an identified user at the multi-user service through the voice user interface. The method also includes retrieving, from memory, a language model specific to the identified user. The language model models one or more language elements. The method also includes applying the retrieved language model, with a processor, to interpret the received voice information and responding to the interpreted voice information.

The language elements modeled by the language model specific to the user can include one or more of: phonemes, words, and/or phrases, and/or can include one or more elements relating to content at the multi-user service associated with the identified user and/or include one or more elements relating to interactive commands of the multi-user service that are especially relevant to the identified user. One or more elements relating to interactive commands of the multi-user service can be identified based on at least one of past usage patterns of the identified user, an applicability of the interactive commands to the content in an account of the identified user, or a status of the account.

In a second aspect, a system for personalizing a voice user interface of a remote multi-user service is disclosed. The system includes at least one processor, at least one computer readable medium communicatively coupled to the at least one processor and a computer program embodied on the at least one computer readable medium. The computer program includes instructions for receiving voice information from an identified user at the multi-user service through a voice user interface, retrieving from memory a language model specific to the identified user, which models one or more language elements, applying the retrieved language model, with a processor, to interpret the received voice information, and instructions for responding to the interpreted voice information.

The language model specific to the identified user can be updated based on the interpreted voice information.

A generic language model can be applied in addition to the language model specific to the identified user, to interpret the received voice information. The generic language model can model a set of language elements, including one or more language elements common to different users of the multi-user service.

The interpreted voice information can include a query in the received voice information responding to the interpreted voice information can include transmitting an aural response to the query to the voice user interface of the identified user.

Any combination or permutation of embodiments are envisioned. Other objects and advantages of the various embodiments will become apparent in view of the following detailed description of the embodiments and the accompanying drawings.

### BRIEF DESCRIPTION OF THE DRAWINGS

FIG. 1 is a block diagram of an exemplary computing device 1000 that may be used to perform any of the methods in the exemplary embodiments.

FIG. 2 is a block diagram of an exemplary network environment 1100 suitable for a distributed implementation of exemplary embodiments.

FIG. 3 is a block diagram of exemplary functional components that may be used or accessed in exemplary embodiments.

FIG. 4 is a flowchart illustrating a method for generating a user profile according to various embodiments taught herein.

FIG. 5 is a flowchart illustrating a method for improved perception of a user response according to various embodiments taught herein.

### DETAILED DESCRIPTION OF EMBODIMENTS OF THE INVENTION

I. Exemplary Computing Devices

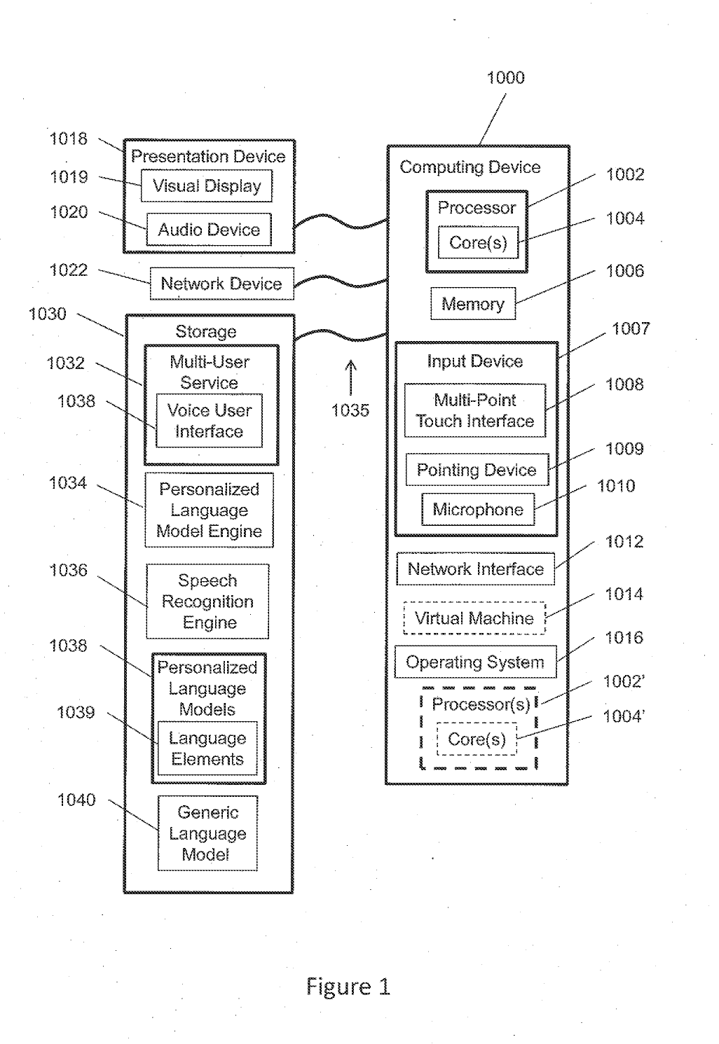

FIG. 1 is a block diagram of an exemplary computing device 1000 that may be used to perform any of the methods in the exemplary embodiments. The computing device 1000 may be any suitable computing or communication device or system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 1000 includes one or more non-transitory computer-readable media for storing one or more computer-executable instructions, programs or software for implementing exemplary embodiments. The non-transitory computer-readable media may include, but are not limited to, one or more types of hardware memory, non-transitory tangible media (for example, one or more magnetic storage disks, one or more optical disks, one or more USB flashdrives), and the like. For example, memory 1006 included in the computing device 1000 may store computer-readable and computer-executable instructions, programs or software for implementing exemplary embodiments. Memory 1006 may include a computer system memory or random access memory, such as DRAM, SRAM, EDO RAM, and the like. Memory 1006 may include other types of memory as well, or combinations thereof.

The computing device 1000 also includes processor 1002 and associated core 1004, and optionally, one or more additional processor(s) 1002′ and associated core(s) 1004′ (for example, in the case of computer systems having multiple processors/cores), for executing computer-readable and computer-executable instructions or software stored in the memory 1006 and other programs for controlling system hardware. Processor 1002 and processor(s) 1002′ may each be a single core processor or multiple core (1004 and 1004′) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

A user may interact with the computing device 1000 through a user interface that may be formed by a presentation device 1018 and one or more associated input devices 1007. For example, presentation device 1018 may be a visual display 1019, audio device (e.g., a speaker) 1020, and/or any other device suitable for providing a visual and/or aural output to a user from the computing device 1000. The associated input devices 1007 may be, for example, a keyboard or any suitable multi-point touch interface 1008, a pointing device (e.g., a mouse) 1009, a microphone 1010, a touch-sensitive screen, a camera, and/or any other suitable device for receiving a tactile and/or audible input from a user. In exemplary embodiments, a user may interact with the computing device 1000 by speaking into the microphone 1011. The speech can represent queries, commands, information, and/or other suitable utterances that can be processed by the computing device 1000 and/or can be processed by a device remote to, but in communication with, the computing device 1000 (e.g., in a server-client environment). The presentation device 1018 can output a response to the user's speech based on, for example, the processing of the user's speech by the computing device 1000 and/or by a device remote to, but in communication with, the computing device 1000 (e.g., in a server-client environment). The response output from the presentation device 1018 can be an audio and/or visual response.

The computing device 1000 may include one or more storage devices 1030, such as a hard-drive, CD-ROM, or other computer readable media, for storing data and computer-readable instructions and/or software that implement portions of exemplary embodiments of a multi-user service 1032, a language model personalization engine 1034, and a speech recognition engine 1036. A multitude of users may access and/or interact with the multi-user service 1032. In exemplary embodiments, the engines 1034 and/or 1036 can be integrated with the multi-user service 1032 or can be in communication with the multi-user service 1032. In exemplary embodiments, the multi-user service 1032 can implement a personalized voice user interface 1033 through which an audible interaction between an identified user and the multi-user service 1032 can occur. The one or more exemplary storage devices 1030 may also store one or more personalized language models 1038 for each user, which may include language elements 1039 generated and/or used by the engine 1034 to configure and/or program the engine 1036 associated with an embodiment of the multi-user service 1032. Additionally or alternatively, the one or more exemplary storage devices 1030 may store one or more default or generic language models 1040, which may include language elements and may be used by the engines 1034 and/or 1036 as taught herein. For example, one or more of the generic language models 1040 can be in conjunction with the personalized language models 1036 and/or can be used as a basis for generating one or more of the personalized language models by adding, deleting, or updating one or more language elements therein. Likewise, the personalized language models can be modified by operation of an embodiment of the engine 1034 as taught herein or separately at any suitable time to add, delete, or update one or more language elements therein. In exemplary embodiments, the language elements can includes phonemes, words, phrases, and/or other verbal cues. The computing device 1000 may communication with the one or more storage devices 1030 via a bus 1035. The bus 1035 may include parallel and/or bit serial connections, and may be wired in either a multidrop (electrical parallel) or daisy chain topology, or connected by switched hubs, as in the case of USB.

The computing device 1000 may include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

II. Exemplary Network Environments

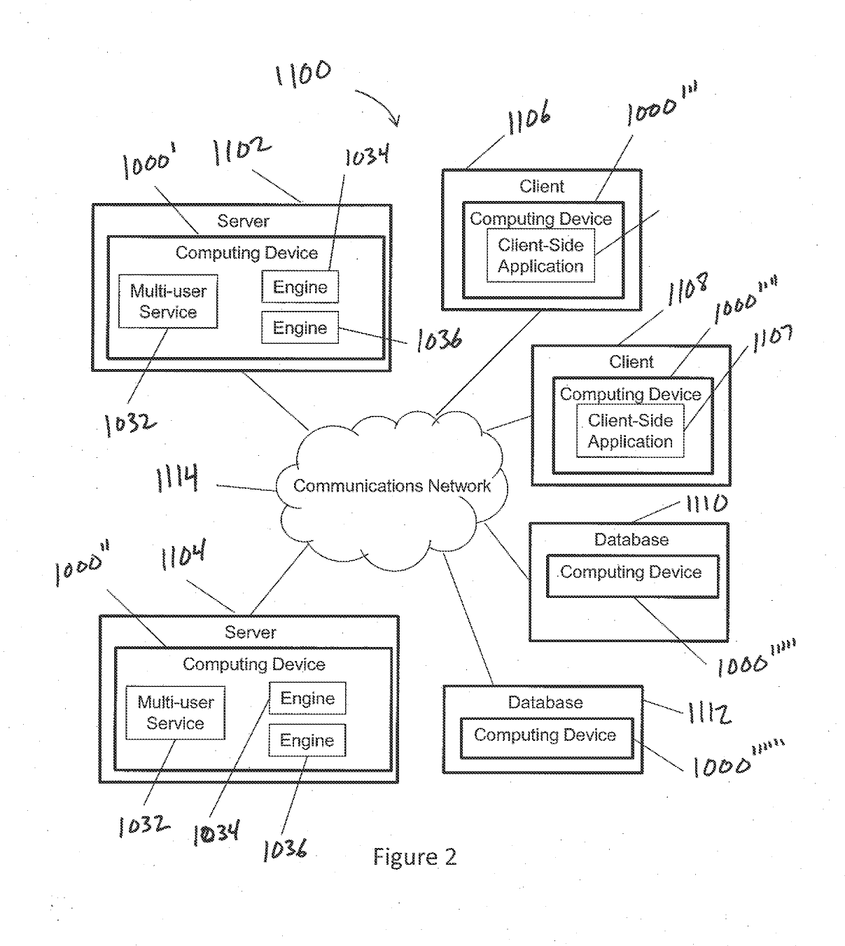

FIG. 2 is a block diagram of an exemplary network environment 1100 suitable for a distributed implementation of exemplary embodiments. The network environment 1100 may include one or more servers 1102 and 1104, one or more clients 1106 and 1108, and one or more databases 1110 and 1112, each of which can be communicatively coupled via a communication network 1114. The servers 1102 and 1104 may take the form of or include one or more computing devices 1000′ and 1000″, respectively, that are similar to the computing device 1000 illustrated in FIG. 1. The clients 1106 and 1108 may take the form of or include one or more computing devices 1000′″ and 1000″″, respectively, that are similar to the computing device 1000 illustrated in FIG. 1. Similarly, the databases 1110 and 1112 may take the form of or include one or more computing devices 1000′″″ and 1000″″″, respectively, that are similar to the computing device 1000 illustrated in FIG. 1. While databases 1110 and 1112 have been illustrated as devices that are separate from the servers 1102 and 1104, those skilled in the art will recognize that the databases 1110 and/or 1112 may be integrated with the servers 1102 and/or 1104.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on the clients 1106 and 1108 to allow users of the clients 1106 and 1108 to access and interact with a multi-user service 1032 installed on the servers 1102 and/or 1104. In some embodiments, the servers 1102 and 1104 may provide the clients 1106 and 1108 with the client-side applications 1107 under a particular condition, such as a license or use agreement. In some embodiments, the clients 1106 and 1108 may obtain the client-side applications 1107 independent of the servers 1106 and 1108. The client-side application 1107 can be computer-readable and/or computer-executable components or products, such as computer-readable and/or computer-executable components or products for presenting a user interface for a multi-user service. One example of a client-side application is a web browser that allows a user to navigate to one or more web pages hosted by the server 1106 and/or the server 1108, which may provide access to the multi-user service. Another example of a client-side application is a mobile application (e.g., a smart phone or tablet application) that can be installed on the clients 1106 and 1108 and can be configured and/or programmed to access a multi-user service implemented by the server 1106 and/or 1108.

In an exemplary embodiment, the clients 1106 and/or 1108 may connect to the servers 1102 and/or 1104 (e.g., via the client-side application) to interact with a multi-user service 1032 on behalf of and/or under the direction of users. A voice user interface may be presented to the users by the client device 1106 and/or 1108 by the client-side application. In some embodiments, the server 1102 and/or 1104 can be configured and/or programmed to host the voice user interface and to serve the voice user interface to the clients 1106 and/or 1108. In some embodiments, the client-side application 1107 can be configured and/or programmed to include the voice user interface. In exemplary embodiments, the voice user interface include enables users of the client 1106 and/or 1108 to interact with the multi-user service using audible signals, e.g., utterances, such as speech, received by a microphone at the clients 1106 and/or 1108.

In an exemplary embodiment, the server 1102 and/or the server 1104 can be configured and/or programmed with the language model personalization engine 1034 and/or the speech recognition engine 1036, which may be integrated with the multi-user service 1032 or may be in communication with the multi-user service 1032 such that the system can be associated with the multi-user service 1032. The engine 1034 can be programmed to generate a personalized language model for users of the multi-user service based on at least an identity of the user. In some embodiments, the multi-user service and/or the system can be implemented by a single server (e.g. server 1102). In some embodiments, an implementation the multi-user service and/or the system can be distributed between two or more servers (e.g., servers 1102 and 1104) such that each server implements a portion or component of the multi-user service and/or a portion or component of the system.

The databases 1110 and 1112 can store user information, previously generated personalized language models, generic language models, and/or any other information suitable for use by the multi-user service and/or the personalized language model engine. The servers 1102 and 1104 can be programmed to generate queries for the databases 1110 and 1112 and to receive responses to the queries, which may include information stored by the databases 1110 and 1112.

III. Exemplary Functional Environments

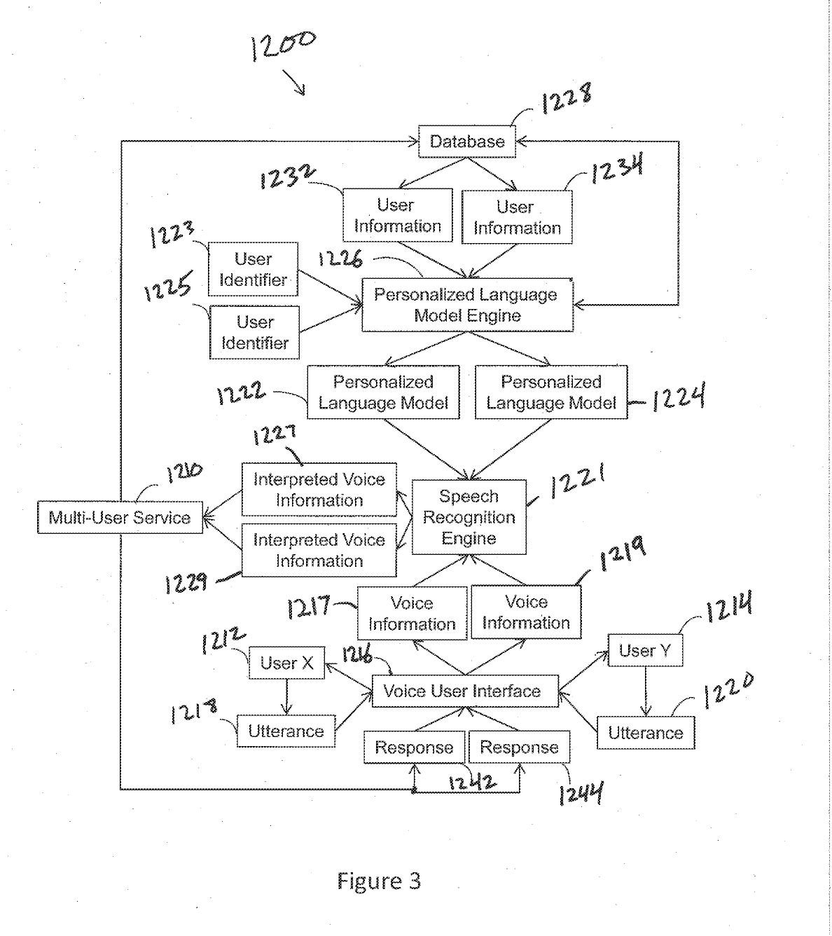

FIG. 3 is a block diagram of an exemplary environment 1200 of functional components that may be used, or accessed, by exemplary embodiments operating in a network environment 1110. For example, in an exemplary embodiment, a multi-user service 1210 can be implemented by one of the servers 1102 and 1104. The multi-user service 1210 may be any service that can be accessed by a multitude of user through client devices (e.g., clients 1106 and/or client 1108). Although FIG. 3 illustrates two exemplary users, a quantity of users of the multi-user service can be generally unlimited such that any number of users using any number of client devices can access and/or interact with the multi-user service 1210. Some examples of a multi-user services that can be implemented by one of the servers includes, but is not limited to, for example, cloud-based digital music services (e.g., Apple iCloud, Google Music), streaming music services (e.g., Pandora, Spotify); digital photos/videos services (e.g., SnapFish, YouTube); social media services (e.g., LinkedIn, FaceBook); dining services (e.g., OpenTable); coupon and discount services (e.g., Groupon, LivingSocial); online banking services; email services (e.g., Gmail, Yahoo Mail), online calendar services; and/or any other remote multi-user services, such as multi-user enterprise service used by employees of an enterprise.

Users 1212 and 1214 (e.g., User X or User Y) can interact with the multi-user server at least partially through a voice user interface 1216. For example, the user 1212 can provide utterance 1218 (e.g., audible user inputs) to the voice user interface 1216, and the voice user interface 1216 can programmatically output voice information 1217 corresponding to the utterance 1218 to a speech recognition engine 1221. Similarly, the user 1214 can provide utterance 1220 to the voice user interface 1216, and the voice user interface 1216 can programmatically output voice information 1219 corresponding to the utterance 1220 to a speech recognition engine 1221. The voice information 1217 and 1219 can correspond to, for example, a query or command.

The speech recognition engine 1221 can be programmed to process and/or interpret the voice information 1217 and 1219 using personalized language models 1222 and 1224, respectively, which have been received from a personalized language model engine 1226. The personalized language model 1222 can be specific to the user 1212 and the personalized language model 1224 can be specific to the user 1214 so that each of the users (e.g., users 1212 and 1214) of the multi-user system 1210 can have a corresponding personalized language model.

The personalized language engine 1226 can be configured and/or programmed to generate and/or retrieve personalized language models (e.g., models 1222 and 1224) for the users (e.g., users 1212 and 1214) of the multi-user service 1210. The personalized language models 1222 and 1224 can include language elements and can be stored in a database 1228 to associate personalized language models 1222 and 1224 with user identifiers 1223 and 1225 associated with the users 1212 and 1214, respectively.

As one example, each of the users 1212 and 1214 can individually register with the multi-user service 1210, e.g., by creating an account with or subscribing to the multi-user service 1210. When the users 1212 and 1214 register with the multi-user service, usernames and/or passwords may be provided to or created by the users 1212 and 1214 as the user identifiers 1223 and 1225 that can be used by the multi-user service and/or the personalized language model engine 1226 to identify and distinguish the users 1212 and 1214. The personalized language models 1222 and 1224 can be mapped to the usernames and/or passwords. The users 1212 and 1214 may provide the usernames and/or passwords (e.g., user identifiers 1223 and 1225) to initiate access to, or log on to, the multi-user service.

As another example, the multi-user service 1210 and/or engine 1226 can use an Internet Protocol (IP) address and/or a Machine Access Code (MAC) address associated with client devices being used by the users 1212 and 1214 as user identifiers 1223 and 1225 to identify the users 1212 and 1214, respectively. The personalized language models 1222 and 1224 can be mapped to the IP and/or MAC addresses.

The engine 1226 can be configured and/or programmed to process the user identifiers 1223 and 1225 and query the database 1228 to retrieve/extract user information 1232 and 1234 associated with the user identifiers 1223 and 1225, respectively. User information can include, but is not limited to, a user's content maintained by the multi-user service; a user's ethnicity; accent information; a language spoken; information related to previous interactions with the multi-user service including, e.g., previously used interactive voice commands or operations; past voice user interface usage patterns; an applicability of interactive commands to content in a multi-user service account of the identified user; a status of the multi-user service account; and/or any other information suitable for by the engine 1226 when creating and/or modifying a personalized language model for an identified user associated with the user information.

Content of a user's multi-user service account can include, for example, media content, contacts, financial account information, calendar information, message information, documents, and/or any other content that can be stored and/or maintained in a multi-user service account. As one example, a user's media content can include music, videos, and images, as well as metadata associated with the music, videos, and images. Metadata for music can include, for example, artist names, album titles, song titles, playlists, music genres, and/or any other information related to the music. Metadata for videos can include, for example, video titles (e.g., movie names), actor names, director names, movie genres, and/or any other information related to the videos. As another example, financial account information can include types of accounts maintained by the multi-user service, a monetary balance in the account, recent transaction using the account, scheduled transactions using the account, bill/invoice information paid electronically using the account, and/or any other information maintained in the multi-user service account.

The user information 1232 and 1234 can be provided to the personalized language model engine 1226 and the engine 1226 can programmatically construct a personalized language model or can modify an existing personalized language model associated with the user identifiers 1223 and 1225 based on the user information 1232 and 1234, respectively. For example, the engine 1226 can construct a personalized language model for each user/subscriber of a multi-user service. The personalized language model can include language elements, such as phonemes, words, and/or phrases. In exemplary embodiments, the language elements in a personalized language model can relate to the content maintained by the multi-user service for user and/or can include elements relating to interactive commands of the multi-user service. The inclusion of the interactive commands can be based on commands that especially relevant to the user, past usage patterns of the user, an applicability of the interactive commands to the content of the user's multi-user service account, and/or a status of the account. In some embodiments, a personalized language model can be constructed each time the user accesses the multi-user service. In some embodiments, a personalized language model can be constructed when the user initially accesses the multi-user service for the first time and the personalized language model can be stored in the database 1228. The stored personalized language model can be used and/or modified when the user accesses the multi-user service at subsequent time and/or can be modified at any other suitable time.

The personalized language models 1222 and 1224 can be provided to the speech recognition engine 1221, which can programmatically process the voice information 1217 and 1219 to generate interpreted voice information 1227 and 1229, which can be input to the multi-user service 1210. For example, the personalized language model 1222 can be dynamically applied to the speech recognition engine 1221 (e.g., as an enhancement to the un-adapted or generic baseline language model), and the speech recognition engine 1221 can process the voice information 1217 of user 1212 with the benefit of the personalized language model 1222 for the user 1212. Likewise, the personalized language model 1224 can be dynamically applied to the speech recognition engine 1221 (e.g., as an enhancement to the un-adapted or generic baseline language model), and the speech recognition engine 1221 can process the voice information 1219 of user 1214 with the benefit of the personalized language model 1224 for the user 1214. Exemplary speech engines configured to receive and apply dynamic language models are described in U.S. Pat. Nos. 7,324,945 and 7,013,275, the disclosures of which are incorporated by reference herein in their entirety. In exemplary embodiments, a generic language model can be used in conjunction with the personalized language model to interpret the received voice information. The generic language model can include one or more language elements that are common among different users of the multi-user service so that redundancy between the personalized language models can be minimized.

The multi-user service can be programmed to process the interpreted voice information 1227 and 1229 received from the speech recognition engine 1221, generate a response 1242 based on the interpreted voice information 1227 corresponding to the voice information 1217, and generate a response 1244 based on the interpreted voice information 1229 corresponding to the voice information 1219. In some embodiments, the interpreted voice information can correspond to a query in the received voice information and the multi-user service can respond by transmitting an aural response to the query to the voice user interface.

In an exemplary embodiment, changes (e.g., additions, deletions, modifications) to the content maintained by the multi-user service and/or interactions between the multi-user service and a user including interpreted voice information and non-voice information can be used to update the user information stored in the database 1228. The updated user information can be used to modify the personalized language model for the user such that personalized language model can be responsive to user-specific content and/or interactions with the multi-user service. The personalized language model for a user of the service can continue to evolve over time to dynamically adapt and/or improve recognition of the identified user's speech.

IV. Exemplary Methods for Personalizing a Voice User Interface of a Remote Multi-User Service

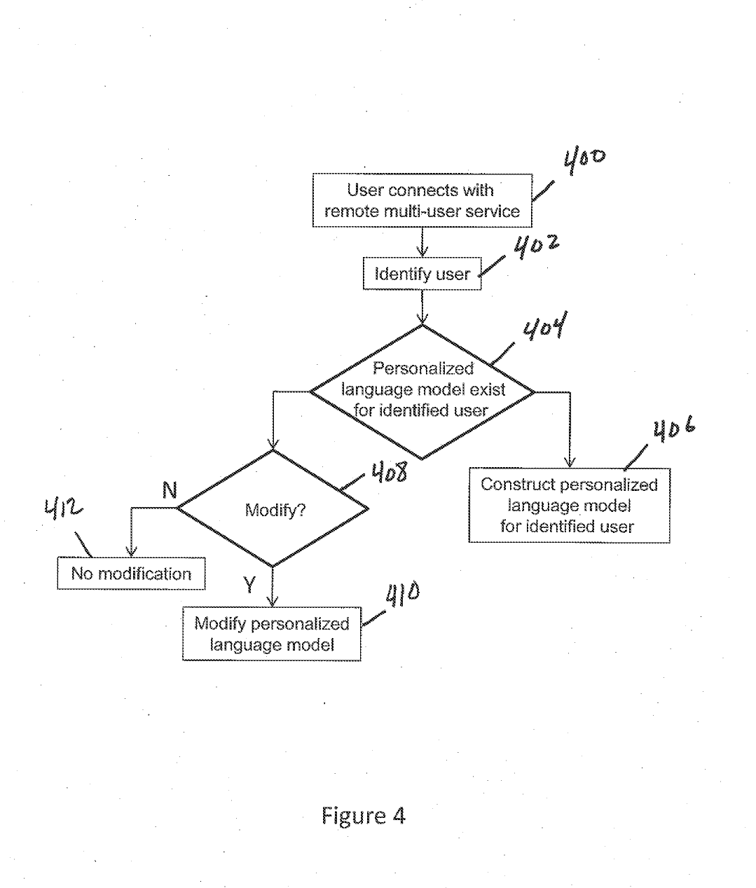

FIG. 4 illustrates a method for generating or modifying a personalized language model for an identified user. In step 400, a user connects with a remote multi-user service implemented by one or more servers. In step 402, the multi-user service identifies the user. The user can be identified, for example, based on login information entered by the user and/or based on an IP or MAC address associated with the client device being used by the user to access the multi-use service. In step 404, the multi-user service can determine (e.g., via a personalized language model engine) whether a personalized language model already exists for the identified user. If not, the multi-user service (e.g., via a personalized language model engine) can construct a personalized language model for the identified user in step 406. The personalized language model can be constructed for the user based on user information accessible by the user, such as, for example, the content of the user's multi-user service account and/or the metadata associated therewith. If a personalized language model already exists, the multi-user service (e.g., via a personalized language model engine) determines whether to modify the personalized language model in step 408. If it is determined to modify the personalized language model, the personalized language model is modified in step 410. Otherwise, no modification occurs as shown in step 412.

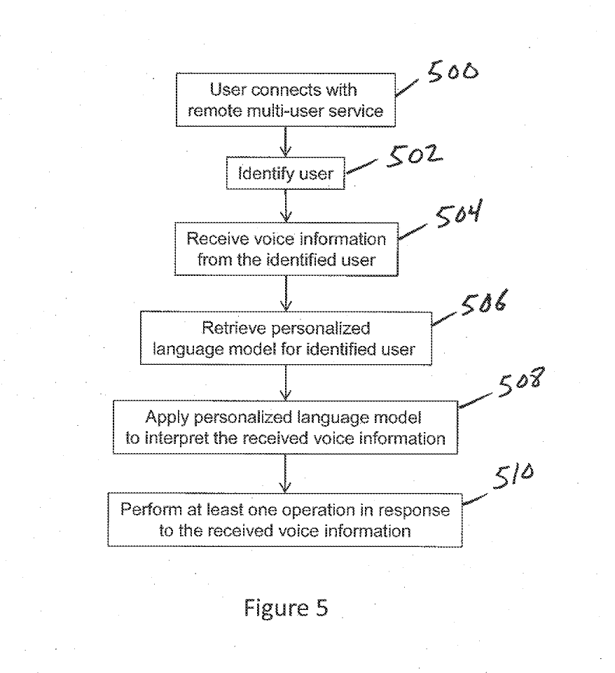

FIG. 5 illustrates a method for implementing a personalized language model for an identified user in a remote multi-user service. In step 500, a user connects with a remote multi-user service implemented by one or more servers. In step 502, the multi-user service identifies the user. The user can be identified, for example, based on login information entered by the user and/or based on an IP or MAC address associated with the client device being used by the user to access the multi-use service. In step 504, the multi-user service can receive voice information from the identified user. The voice information can correspond to an utterance made by the user and captured via a voice user interface. In step 506, a personalized language model can be retrieved for the identified user. In step 508, the personalized language model can be applied to a speech recognition engine associated with the multi-user service to interpret the voice information received from the identified user. In step 510, the interpreted voice information can be used by the multi-user service to perform at least on operation in response to the received voice information. For example, for embodiments in which the multi-user service is implemented as a streaming music service, the voice information can request the streaming music service to play songs of a particular genre and the streaming music service can begin to play the requested songs.

VI. Exemplary Use

An exemplary a multitude of users may access a remote multi-user service through the communication network. The multi-user service can be implemented by the server and the personalized language model engine and the speech recognition engine can be integrated with the multi-user service. Each user may be required to login to the multi-user service by entering a username and/or a password and the multi-user service can identify each user based on the user's username and/or password. Each user can interact with the multi-user service using speech by, for example, speaking into a microphone on the user's client device. The speech can be transmitted from the user's client device to a voice user interface of the multi-user service, which can pass voice information corresponding to utterances of the user to a speech recognition engine. The speech recognition engine can process the voice information by applying a personalized language model for the identified user to interpret the voice information and the interpreted voice information can be processed by the multi-user service to generate a response.

Based on the teachings herein, one of ordinary skill in the art will recognize numerous changes and modifications that may be made to the above-described and other embodiments of the present disclosure without departing from the spirit of the invention as defined in the appended claims. Accordingly, this detailed description of embodiments is to be taken in an illustrative, as opposed to a limiting, sense.

What is claimed is:

1. A computer-implemented method for personalizing a voice user interface of a remote multi-user service, the method comprising:
providing a voice user interface for the remote multi-user service;
receiving voice information from an identified user at the multi-user service through the voice user interface;
retrieving from memory a language model specific to the identified user, which models one or more language elements;
applying the retrieved language model, with a processor, to interpret the received voice information; and
responding to the interpreted voice information.

2. The method of claim 1 wherein the language elements include one or more elements relating to content at the multi-user service associated with the identified user.

3. The method of claim 1 wherein the language elements include one or more elements relating to interactive commands of the multi-user service that are especially relevant to the identified user.

4. The method of claim 3, further comprising identifying the one or more elements relating to interactive commands of the multi-user service based on at least one of past usage patterns of the identified user, an applicability of the interactive commands to the content in an account of the identified user, or a status of the account.

5. The method of claim 1 wherein the language elements comprise one or more of: phonemes, words, phrases.

6. The method of claim 1 further comprising updating the language model specific to the identified user based on the interpreted voice information.

7. The method of claim 1 further comprising applying, with a processor, a generic language model in addition to the language model specific to the identified user, to interpret the received voice information.

8. The method of claim 7 wherein the generic language model models a set of language elements, including one or more language elements common to different users of the multi-user service.

9. The method of claim 1 wherein the interpreted voice information comprises a query in the received voice information.

10. The method of claim 1 wherein responding comprises transmitting an aural response to the query to the voice user interface of the identified user.

11. A system for personalizing a voice user interface of a remote multi-user service, the system comprising:
at least one processor;
at least one computer readable medium communicatively coupled to the at least one processor; and
a computer program embodied on the at least one computer readable medium, the computer program comprising:
instructions for receiving voice information from an identified user at the multi-user service through a voice user interface;
instructions for retrieving from memory a language model specific to the identified user, which models one or more language elements;
instructions for applying the retrieved language model, with a processor, to interpret the received voice information; and
instructions for responding to the interpreted voice information.

12. The system of claim 11 wherein the language elements include one or more elements relating to content at the multi-user service associated with the identified user.

13. The system of claim 11 wherein the language elements include one or more elements relating to interactive commands of the multi-user service that are especially relevant to the identified user.

14. The system of claim 13, wherein the computer program further comprising instructions for identifying the one or more elements relating to interactive commands of the multi-user service based on at least one of past usage patterns of the identified user, an applicability of the interactive commands to the content in an account of the identified user, or a status of the account.

15. The system of claim 11 wherein the language elements comprise one or more of: phonemes, words, phrases.

16. The system of claim 11 wherein the computer program further comprises instructions for updating the language model specific to the identified user in memory based on the interpreted voice information.

17. The system of claim 11 wherein the computer program further comprises instructions for applying a generic language model in addition to the language model specific to the identified user, to interpret the received voice information.

18. The system of claim 17 wherein the generic language model models a set of language elements, including one or more language elements common to different users of the multi-user service.

19. The system of claim 11 wherein the interpreted voice information comprises a query in the received voice information.

20. The system of claim 11 wherein instructions for responding further comprise instructions for transmitting an aural response to the query to the voice user interface of the identified user.
